(19) United States
(12) Patent Application Publication
(10) Pub. No.: US 2018/0208133 A1
(43) Pub. Date: Jul. 26, 2018

(54) WIRE HARNESS AND METHOD FOR MANUFACTURING THE SAME

(71) Applicants: AUTONETWORKS TECHNOLOGIES, LTD., Yokkaichi, Mie (JP); SUMITOMO WIRING SYSTEMS, LTD., Yokkaichi, Mie (JP); SUMITOMO ELECTRIC INDUSTRIES, LTD., Osaka-shi, Osaka (JP)

(72) Inventors: Tetsuya MIYAMURA, Yokkaichi, Mie (JP); Yasuo OMORI, Yokkaichi, Mie (JP)

(21) Appl. No.: 15/745,616

(22) PCT Filed: Jul. 8, 2016
(86) PCT No.: PCT/JP2016/070344

§ 371 Date: Jan. 17, 2018

(30) Foreign Application Priority Data
Jul. 28, 2015 (JP) 2015-148441

(51) Int. Cl. B60R 16/02; H01B 13/012

(52) U.S. Cl. CPC B60R 16/0215; H01B 13/01263

(57) ABSTRACT

A wire harness in which a trunk line section and a branch line section are divided and which is capable of protecting the divided sections, and a method for manufacturing the wire harness. The wire harness is provided with: a trunk line harness; a branch line harness; a trunk line connector provided at an intermediate section of the trunk line harness; a branch line connector which is provided at the end portion of the branch line harness and which can be coupled to the trunk line connector; and a connector protector. The connector protector includes a connector protecting member which extends across the trunk line harness and the branch line connector. The connector protecting member includes a trunk-line-side linking portion linked to the trunk line harness, and a branch-line-side linking portion linked to the branch line connector, and by the two linking portions and being provided in one piece, relative displacement between the connectors is restricted.

### CROSS REFERENCE TO RELATED APPLICATIONS

This application claims the priority of Japanese patent application JP2015-148441 filed on Jul. 28, 2015, the entire contents of which are incorporated herein.

### TECHNICAL FIELD

The present invention relates to a wire harness including a plurality of sections that are divided and coupled to each other with a connector, and a method for manufacturing the wire harness.

### BACKGROUND ART

In recent years, as wire harnesses becomes increasingly larger and more complex, techniques for dividing a wire harness and interconnecting the divided sections with a connector have been considered. For example, Patent Document 1 (JP2002-204521A) discloses a technique to divide a wire harness mounted to an automobile into a plurality of sub-harnesses, and to connect the divided sub-harnesses to each other via a connector.

The inventors have focused on a branch portion, which is the location where a trunk line portion is connected to a branch line portion, as a dividing point that is suitable for rationalizing the assembly of the wire harness. Dividing the trunk line portion from the branch line portion at this branch portion allows for configuration of a plurality of wire harnesses corresponding to various types of automobiles or specifications at low cost and in a rational way, for example, by using a common trunk line portion while changing the branch line portion connected to a terminal device depending on the kind and grade of the device.

However, a heavy load tends to act on the branch portion due to the tension applied to the branch portion when the wire harness is mounted and relative displacement between the trunk line portion and the branch line portion when the vehicle moves, so that it is difficult to set the branch portion as a dividing point, in other words, it is difficult to divide the trunk line portion from the branch line portion and to couple connectors provided to the two at the branch portion. Specifically, in the case where connectors fitting to each other (a trunk-line-side connector and a branch-line-side connector) are arranged at the branch portion, there is a risk that a heavy load acting on the branch portion will cause a relative displacement between the trunk-line-side connector and the branch-line-side connector, and thus will generate a subtle relative displacement between the terminals of the connectors fitted to each other, whereby abrasion of contact portions of the terminals will be accelerated, and in the worst case, the connectors will be separated.

An object of the present design is to provide a wire harness in which a trunk line section and a branch line section are divided from each other, and which is capable of protecting the divided sections effectively from a heavy load.

The wire harness is provided with: a trunk line harness that includes a plurality of electrical wires that are bundled together; a branch line harness that includes a plurality of electrical wires that are bundled together and that is connectable to the trunk line harness so as to branch from an intermediate section of the trunk line harness; a trunk line connector provided in the intermediate section of the trunk line harness; a branch line connector that is provided at an end portion of the branch line harness, and that connects the electrical wires included in the trunk line harness and the electrical wires included in the branch line harness mutually and electrically by being coupled with the trunk line connector; and a connector protector for protecting the trunk line connector and the branch line connector from a load acting on the branch line harness. The connector protector includes a connector protecting member arranged across the trunk line harness and the branch line connector, and the connector protecting member includes a trunk-line-side linking portion linked and fixed to the trunk line harness, and a branch-line-side linking portion linked and fixed to the branch line connector, and due to the trunk-line-side linking portion and the branch-line-side linking portion being provided in one piece, fixing the relative position of the trunk-line-side linking portion and the branch-line-side linking portion, relative displacement between the trunk line connector and the branch line connector is restricted in response to a load acting on the branch line harness.

### BRIEF DESCRIPTION OF DRAWINGS

FIG. 1 is a perspective view showing a main part of a wire harness according to a first embodiment.

FIG. 2 is a plan view showing the main part of the wire harness shown in FIG. 1.

FIG. 3 shows a cross-sectional view taken along line III-III in FIG. 2.

FIG. 4 shows a cross-sectional view taken along line IV-IV in FIG. 2.

FIG. 5 is a perspective view of a connector protecting member that is part of the wire harness shown in FIG. 1.

FIG. 6 is a bottom view of the connector protecting member.

FIG. 7 is a side view of the connector protecting member.

FIG. 8 is a perspective view showing a main part of the wire harness according to a second embodiment.

FIG. 9 is a plan view showing the main part of the wire harness shown in FIG. 8 in a state in which a cover of a harness protector is removed.

FIG. 10 shows a cross-sectional view taken along line X-X in FIG. 9.

FIG. 11 shows a cross-sectional view taken along line XI-XI in FIG. 9.

FIG. 12 is a perspective view of the harness protector.

### DESCRIPTION OF EMBODIMENTS

Preferred embodiments are described with reference to the figures.

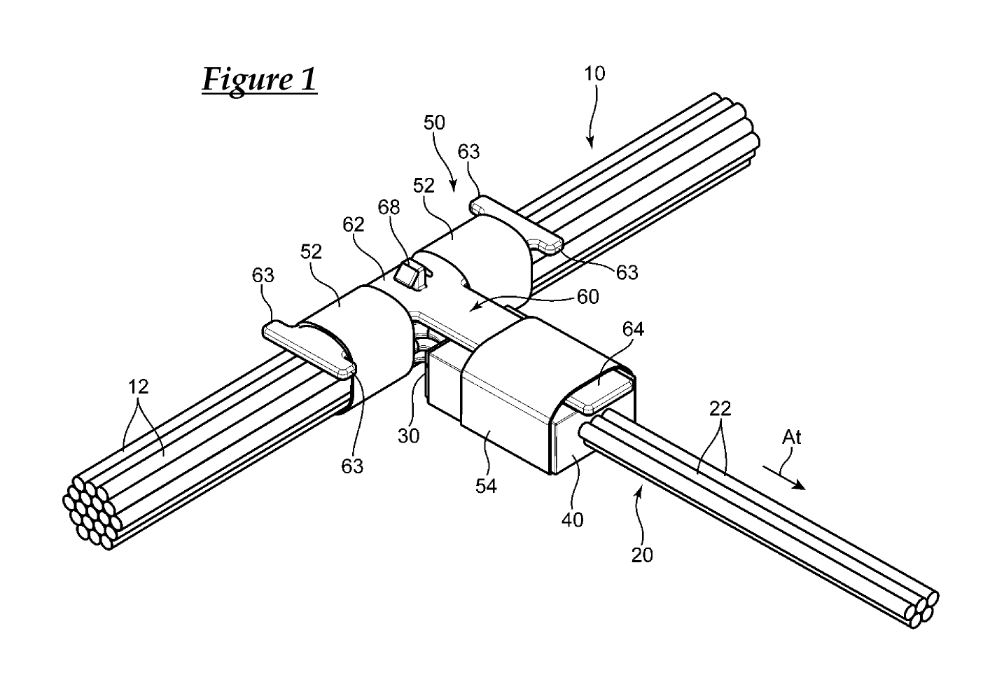

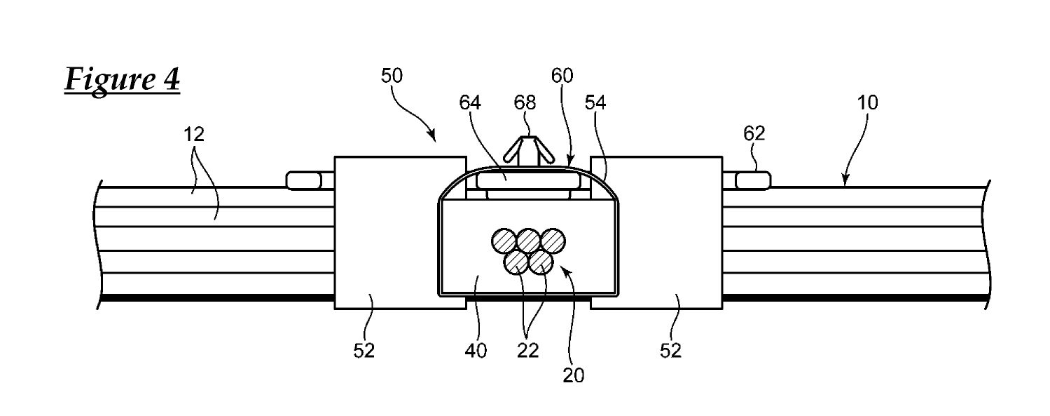

FIGS. 1 to 4 show a main part of a wire harness according to a first embodiment. This wire harness is provided with a trunk line harness 10, a branch line harness 20, a trunk line connector 30, a branch line connector 40, and a connector protector 50.

The trunk line harness 10 includes a plurality of electrical wires 12 that are bundled together. The branch line harness 20 includes a plurality of electrical wires 22 that are bundled together, and is capable of connecting to the trunk line harness 10 so as to branch from an intermediate section of the trunk line harness 10.

The trunk line connector 30 is provided at an intermediate section of the trunk line harness. Specifically, the trunk line connector 30 is provided at a terminal end of those electrical wires 12 in the trunk line harness 10 that are branch-connected to the branch line harness 20. The trunk line connector 30 has a plurality of connector terminals that are attached to the ends of the electrical wires 12 to be branch-connected, and a connector housing holding these connector terminals. Only the connector housing is shown in FIGS. 1 to 4.

The branch line connector 40 is provided at a base end portion at one end of the branch line harness 20 that is to be connected to the trunk line harness 10, and connects the electrical wires 12 included in the trunk line harness 10 that are to be branch-connected and the electrical wires 22 included in the branch line harness 20 electrically to each other, by coupling with the trunk line connector 30. This branch line connector 40 has a plurality of connector terminals respectively attached to ends of the plurality of electrical wires 22 and a connector housing that holds these connector terminals. Only the connector housing is shown in FIGS. 1 to 4. On the other hand, a front end portion at the other end of the branch line harness 20 is connected to various devices to be connected to the end of the wire harness.

The connector protector 50 is for protecting the trunk line connector 30 and the branch line connector 40 from loads acting on the branch line harness 20, especially a tension load shown with arrow At in FIG. 1, and includes a connector protecting member 60 reaching from the trunk line harness 10 to the branch line connector 40.

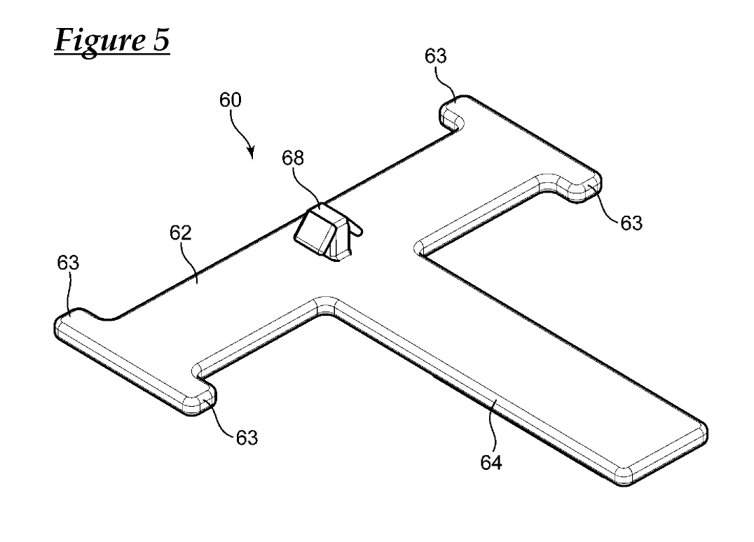

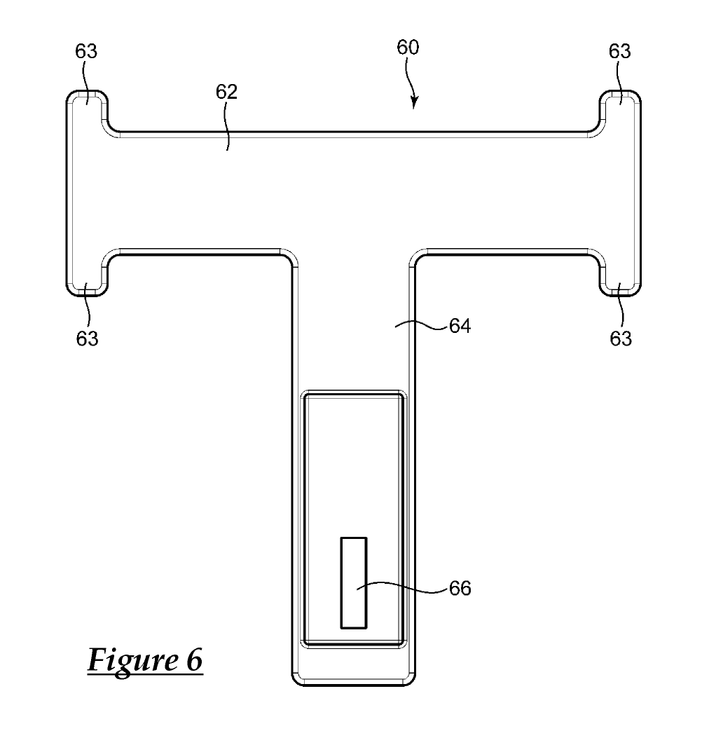

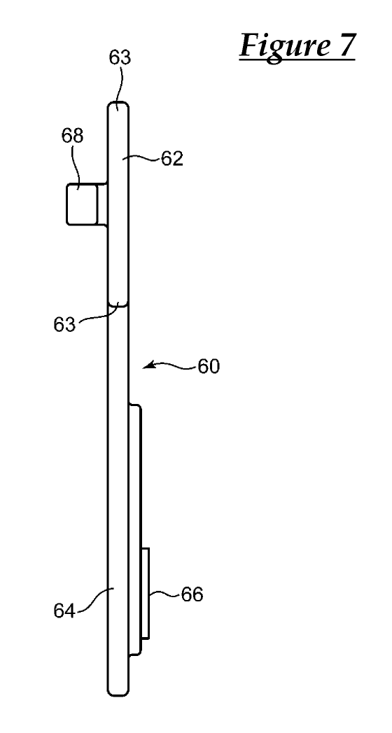

As shown in FIGS. 5 to 7, the connector protecting member 60 according to this embodiment is made of a single plate material, and has a trunk-line-side linking portion 62 and a branch-line-side linking portion 64 provided in one piece.

The trunk-line-side linking portion 62 is linked and fixed to the trunk line harness 10, and extends in the longitudinal direction of the trunk line harness 10. The trunk-line-side linking portion 62 according to this embodiment is substantially rectangular with a constant width in the direction perpendicular to the longitudinal direction of the trunk line harness 10.

The branch-line-side linking portion 64 is linked and fixed to the branch line connector 40 and branches from an intermediate section in the longitudinal direction of the trunk-line-side linking portion 62, in the direction perpendicular to the longitudinal direction in this embodiment. Also, this branch-line-side linking portion 64, just like the trunk-line-side linking portion 62, is substantially rectangular with a constant width in a direction perpendicular to the longitudinal direction of the branch-line-side linking portion 64.

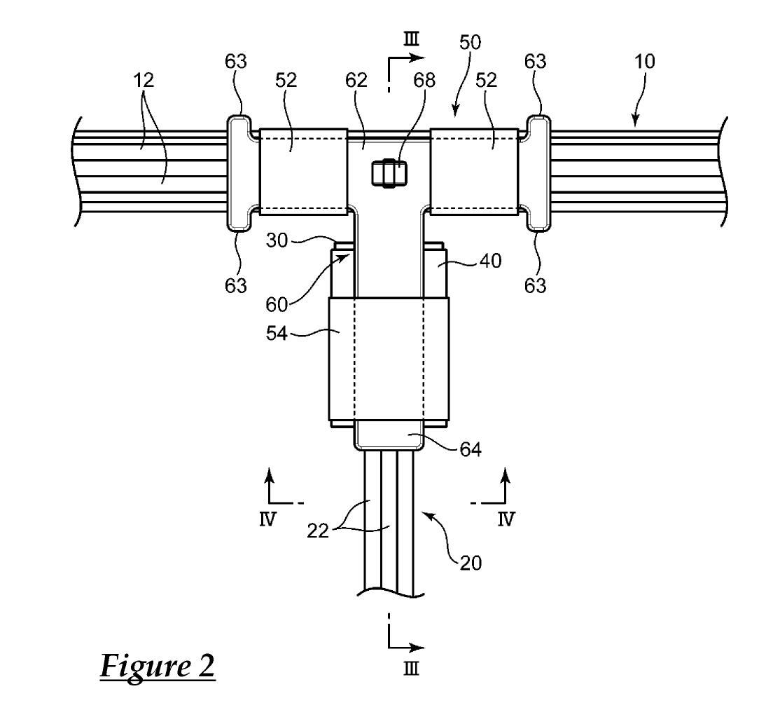

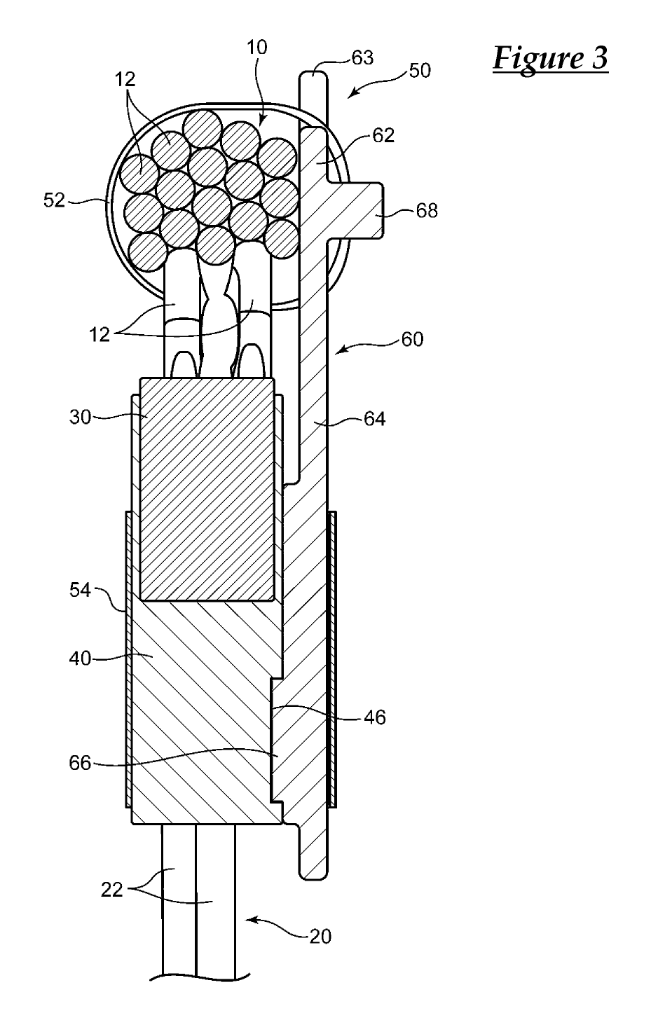

Furthermore, the branch-line-side linking portion 64 and the branch line connector 40 according to this embodiment have an engaging part 66 and an engaging part 46 as shown in FIG. 3, respectively. These engaging parts 66 and 46 engage with each other, thereby restricting relative displacement of the branch line connector 40 in the direction to which the branch line connector 40 separates from the trunk-line-side linking portion 62 (downward in FIGS. 2 and 3). Specifically, the engaging part 66 of the branch-line-side linking portion 64 is protrudes toward the branch line connector 40 on that surface of the branch-line-side linking portion 64 that faces the branch line connector 40 (rear surface). The engaging part 46 of the branch line connector 40 is recessed to receive the engaging part 66 fitted into it on that surface of the external surface of the connector housing of the branch line connector 40 that faces the branch-line-side linking portion 64.

The connector protector 50 further has binders 52 for the trunk line and a binder 54 for the branch line. The binders 52 for the trunk line are, for example, made of an adhesive tape, and are adhered to and wound around an outer periphery of the trunk line harness 10 along with predetermined portions of the trunk-line-side linking portion 62, that is in this embodiment, the two of the portions of the trunk-line-side linking potion 62 flanking a central part that is linked to the branch-line-side linking portion 64. Thereby, the binders 52 for the trunk line bind the trunk line harness 10 and the branch-line-side linking portion 62 together, thus fixing the trunk-line-side linking portion 62 to the trunk line harness 10. Similarly, the binder 54 for the branch line is, for example, made of an adhesive tape with a constant width, and is adhered to and wound around the branch-line-side linking portion 64 along with the branch line connector 44, in a state where the engaging parts 66 and 46 engage with each other. Thereby, the binder 54 for the branch line binds the branch-line-side linking portion 64 and the branch line connector 40 together, thus fixing the branch-line-side linking potion 64 to the branch line connector 40. Each of the binders 52 and 54 may also be constituted by a binder other than an adhesive tape, for example, a binding band that does not have adhesive force but has a strong tightening force.

At both longitudinal ends of the trunk-line-side linking portion 62, positioning projections 63 are formed that protrude further outward in the width direction than its other portions. These positioning projections 63 are for restricting the position of the outside end of the binders 54 for the trunk line that are wound around the trunk-line-side linking portion 62.

Furthermore, the connector protecting member 60 according to this embodiment has a fixed part 68 for fixing the wire harness to an appropriate part of a vehicle to which the wire harness is mounted, for example, a car body. The fixed part 68 protrudes outward (the side opposite to the trunk line harness 10) from a central section of the trunk-line-side linking portion 62, that is, a section where the branch-line-side linking portion 64 branches from the trunk-line-side linking portion 62, and is linked to the vehicle by being press-fit to a hole disposed at the vehicle. This linking of the fixed part 68 at the branch portion to the vehicle enables both the trunk-line-harness 10 and the branch-line-harness 20 to be fixed effectively to the vehicle. The fixed part 68 may also be omitted.

The wire harness as described above may be manufactured by the steps of: preparing the trunk line harness 10 with the trunk line connector 30 attached thereto and the branch line harness 20 with the branch line connector 40 attached thereto; coupling the trunk line connector 30 and the branch line connector 40 to connect the electrical wires 12 included in the trunk line harness 10 and the electrical wires 22 included in the branch line harness 20 electrically; linking and fixing the trunk-line-side linking portion 62 and the branch-line-side linking portion 64 of the connector protecting member 60 to the trunk line harness 10 and the branch line connector 40 by using the binders 52 for the trunk line and the binder 54 for the branch line, respectively.

According to this wire harness, due to the trunk line harness 10 and the branch line harness 20 being divided, diversification of the wire harness is possible at low cost, for example, by using a common harness as the trunk line harness 10 and changing the branch line harness 20 depending on the kind of device to be connected thereto. Also, the assembly of the wire harness is easier than that of a wire harness that is completely integrated.

Furthermore, although the part where the trunk line harness 10 is connected to the branch line harness 20, that is, the part where the trunk line connector 30 and the branch line connector 40 for connecting the two are disposed is arranged in the branching section which is subject to heavy loads, it is possible to restrict relative displacement between the trunk line connector 30 and the branch line connector 40 in response to loads acting on the branch line harness 20, due to the connector protecting member 60 reaching from the trunk line harness 10 to the branch line connector 40 and being fixed to them. For example, even when a tension load acts on the branch line harness 20, it is possible to maintain a state in which an appropriate extra length is afforded to the electrical wires in the trunk line harness 10 that are connected to the trunk line connector 30. Thus, the abrasion of contact portion caused by relative displacement between the two connectors 30 and 40 can be restricted, and also the separation of the connectors 30 and 40 can be prevented.

Especially, in this embodiment, the trunk-line-side linking portion 62 of the connector protecting member 60 extends in the longitudinal direction of the trunk line harness 10, so that the trunk-line-side linking portion 62 can be fixed stably on the outer periphery of the trunk line harness 10. Furthermore, by linking, to the branch line connector 40, the branch-line-side linking portion 64 extending from the trunk-line-side linking portion 62 in the predetermined branching direction while being connected in one piece to the trunk-line-side-linking portion 62, relative displacement of the branch line connector 40 with respect to the trunk line harness 10 can be suppressed more effectively.

In addition, due to the engagement of the engaging parts 66 and 46 that are respectively disposed on the branch-line-side linking portion 64 and the branch-line connector 40, relative displacement of the branch line connector 40 with respect to the branch-line-side linking portion 64, and thus relative displacement of the branch line connector 40 with respect to the trunk line harness 10, can be restricted more reliably, whereby the protective effect on the connectors 30 and 40 can be enhanced even more.

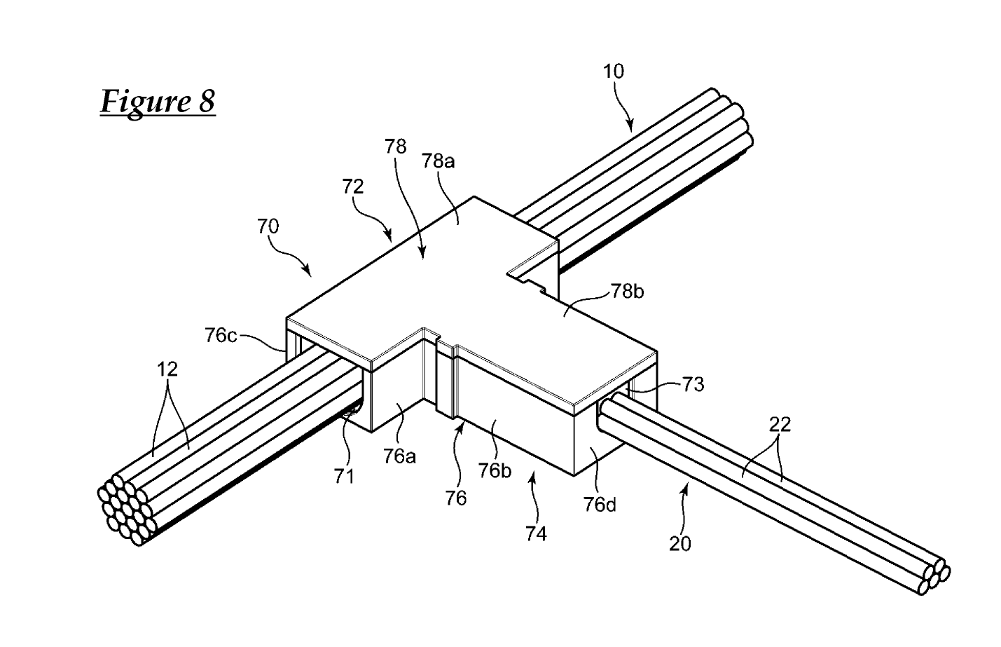

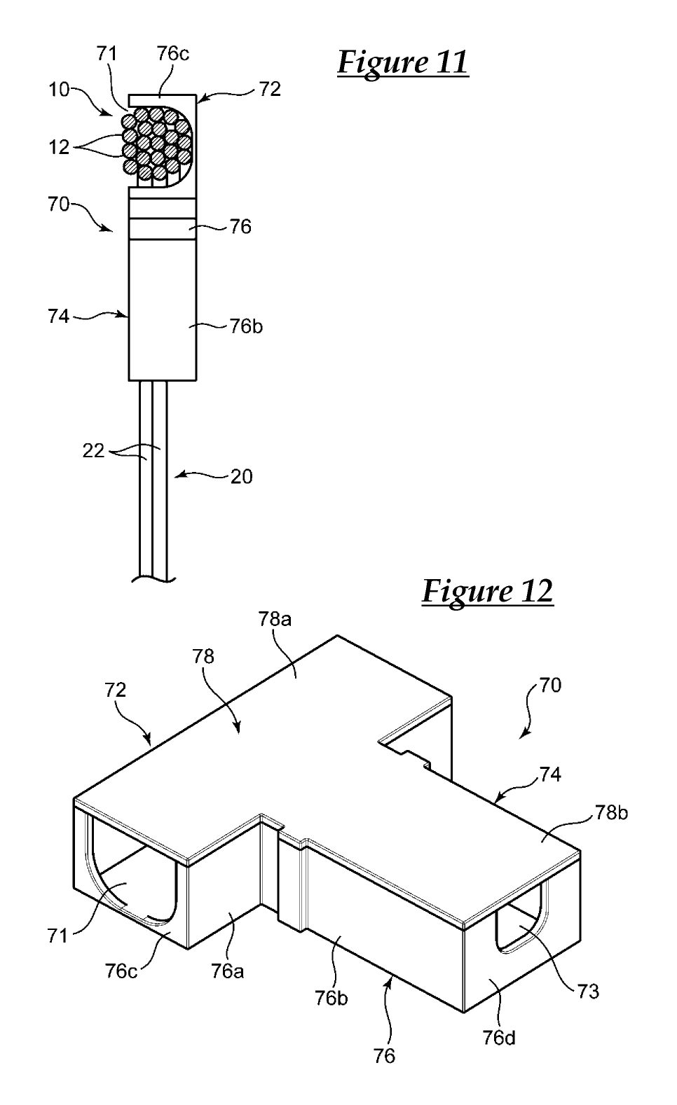

FIGS. 8 to 11 show a main part of a wire harness according to a second embodiment. This wire harness has a trunk line harness 10, a branch line harness 20, a trunk line connector 30 and a branch line connector 40, that are equivalent to the trunk line harness 10, the branch line harness 20, the trunk line connector 30 and the branch line connector 40 according to the first embodiment, and is provided with a harness protector 70 as shown in FIG. 12, instead of the connector protector 50 according to the first embodiment.

Like the connector protector 50 according to the first embodiment, this harness protector 70 functions as a connector protecting member that restricts relative displacement between the two connectors 30 and 40 while protecting the branching section (preventing contact with other members), by covering the branching section including the two connectors 30 and 40 from the outside in the wire harness.

This harness protector 70 has a trunk line harness housing portion 72 and a branch line harness housing portion 74 provided in one piece. The trunk line harness housing portion 72 is a part which constrains and houses at least that section of the trunk line harness 10 that includes the branch portion that is connected to the trunk line connector 30. The trunk line harness housing portion 72 according to this embodiment is of angular tube shape covering the outer periphery of the trunk line harness 10. The branch line harness housing portion 74 is a part which houses the branch line connector 40 and the trunk line connector 30 coupled thereto, constraining the branch line connector 40, and in this embodiment, is of angular tube shape extending from an intermediate section of the trunk line harness housing portion 72 in the longitudinal direction and covering the connectors 30 and 40.

The harness protector 70 according to this embodiment is divided into a protector body 76 and a cover 78. The protector body 76 is shaped like a container whose upper end surrounds an aperture. The cover 78 is attached to the protector body 76 so as to close the aperture of the protector body 76, and thus constitutes the trunk line harness housing portion 72 and the connector housing portion 74 together with the protector body 76.

The protector body 76 has a first side wall portion 76a, a first end wall portion 76c, a second side wall portion 76b, and a second end wall portion 76d provided in one piece. The first side wall portion 76a constitutes a bottom wall and both side walls of a peripheral wall of the trunk line harness housing portion 72. The first end wall portion 76c constitutes both end walls of the trunk line harness housing portion 72. The second side wall portion 76b constitutes a bottom wall and both side walls of a peripheral wall of the connector housing portion 72. The second end wall portion 76d constitutes an end wall portion of the connector housing portion 74, that is, an end wall portion on the side facing away from the trunk line harness housing portion 72. Both first end wall portions 76c have a cut-out 71 that opens upward, and the cut-out 71 is shaped so as to allow the trunk line harness 10 to penetrate through the cut-out 71. Similarly, both of the second end wall portion 76d has a cut-out 73 that has a shape opening upward, and the cut-out 73 is shaped so as to allow the branch line harness 20 connected to the branch line connector 40 to penetrate through the cut-out 73.

The cover 78 has a first cover plate portion 78a and a second cover plate portion 78b provided in one piece. The first cover plate portion 78a is shaped as a rectangular plate that closes the aperture surrounded by the upper end of the side wall portion 76a of the protector body 76. The first cover plate portion 78a constitutes a peripheral wall of the trunk line harness housing portion 72 together with the first side wall portion 76a by being joined to an upper end of the first side wall portion 76a. Furthermore, both longitudinal ends of the first cover plate portion 78a, together with the first end wall portion 76c, constrain the trunk line harness 10 from outside with an appropriate constraint force. The second cover plate portion 78b branches from an intermediate section of the first cover plate portion 78a in the longitudinal direction, and has a rectangular plate shape that closes the aperture that is surrounded by the upper end of the side wall portion 76b of the protector body 76. The second cover plate portion 78b constitutes a peripheral wall of the connector housing portion 72 together with the second side wall portion 76b by being joined to an upper end of the second side wall portion 76b.

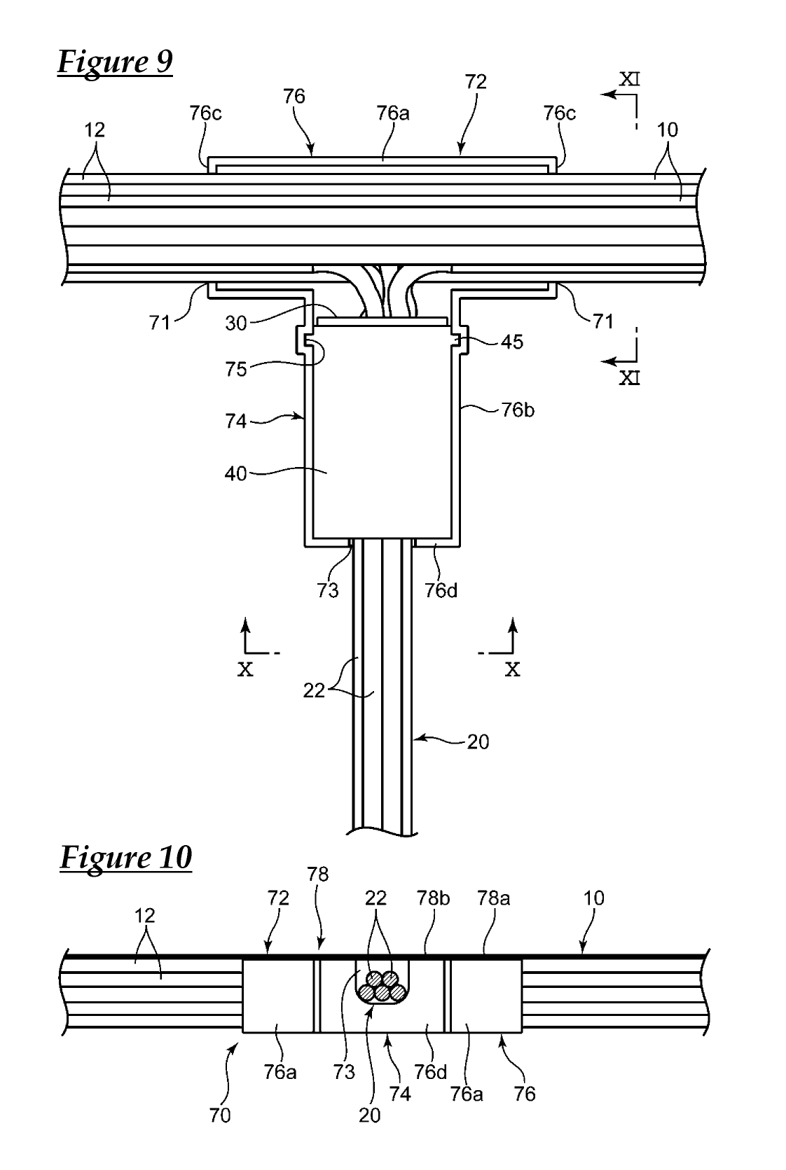

Also, the second end wall portion 76d of the protector body 76 has a function to restrict relative displacement of the branch line connector 40 with respect to the trunk line harness 10 in the direction away from the trunk line harness 10 by constraining the branch line connector 40 from a side that is opposite to the trunk line harness 10 (from the underside in FIG. 9).

Furthermore, in the harness protector 70 according to this embodiment, while an outer surface of the branch line connector 40 includes a connector-side fitting part 45 that protrudes in the direction perpendicular to the longitudinal direction of the branch line harness 20, an inner surface of the second side wall portion 76b constituting the connector housing portion 74 includes a protector-side fitting part 75 that has a recess that can be fitted with the connector-side fitting part 45. The fitting of the fitting parts 45 and 75 reliably restricts relative displacement of the branch line connector 40 with regard to the harness protector 70, especially displacement in the direction in which the branch line connector 40 separates from the trunk line harness 10. This effect is also established if the projection and the recess of the fitting parts 45 and 75 are inverted, that is, also if the connector-side fitting part 45 has a recess and the protector-side fitting part 75 is a projection to be fitted within the recess.

The wire harness according to the second embodiment as described above may, for example, be manufactured by steps of: preparing the trunk line harness 10 with the trunk line connector 30 attached thereto and the branch line harness 20 with the branch line connector 40 attached thereto; coupling the trunk line connector 30 and the branch line connector 40 to connect the electrical wires 12 included in the trunk line harness 10 and the electrical wires 22 included in the branch line harness 20 electrically; linking the trunk line harness housing portion 72 corresponding to the trunk-line-side linking portion to the trunk line harness 10, and the connector housing portion 74 corresponding to the branch-line-side linking portion to the branch line connector 40 by housing and constraining the trunk line harness 10 and the connectors 30 and 40 respectively in the trunk line harness housing portion 72 and the connector housing portion 74 of the harness protector 70.

In this wire harness, by the trunk line harness housing portion 72 and the connector housing portion 74 of the harness protector 70 respectively constraining and housing the trunk line harness 10 and both connectors 30 and 40, the relative displacement between the trunk line connector 30 connected to the trunk line harness 10 and the branch line connector 40 housed in the connector housing portion 74 is effectively restricted, contact of the trunk line harness 10, the trunk line connector 30, and the branch line connector 40 with other members outside the harness protector 70 is prevented, and the protection of these is made more reliable.

The specific shape of the connector protecting member according to the present invention is not limited to that of the connector protecting member 60 or the harness protector 70. For example, if both binders 52 for the trunk lines 52 shown in FIG. 1 are binding bands, then the branch-line-side linking portion may also extend in one piece with and from each of the binding bands and be connected to both right and left sides of the branch line connector 40.

Furthermore, there is no limitation to the specific way in which the connector protecting member is linked to the trunk line harness and the branch line connector. For example, the connector protecting member may also be molded in one piece with the connector housing of the branch line connector.

As described above, a wire harness in which a trunk line section and a branch line section are divided from each other and which is capable of protecting the divided sections effectively from a heavy load, and a method for manufacturing the wire harness are provided.

The wire harness is provided with: a trunk line harness that includes a plurality of electrical wires that are bundled together; a branch line harness that includes a plurality of electrical wires that are bundled together and that is connectable to the trunk line harness, branching from an intermediate section of the trunk line harness; a trunk line connector provided at the intermediate section of the trunk line harness; a branch line connector that is provided at an end portion of the branch line harness, and that connects the electrical wires included in the trunk line harness and the electrical wires included in the branch line harness electrically to each other by being coupled with the trunk line connector; and a connector protector for protecting the trunk line connector and the branch line connector from a load acting on the branch line harness. The connector protector includes a connector protecting member reaching from the trunk line harness to the branch line connector, and the connector protecting member includes a trunk-line-side linking portion linked and fixed to the trunk line harness, and a branch-line-side linking portion linked and fixed to the branch line connector, and relative displacement between the trunk line connector and the branch line connector in response to a load acting on the branch line harness is restricted by the trunk-line-side linking portion and the branch-line-side linking portion being provided in one piece, fixing the relative position of the trunk-line-side linking portion and the branch-line-side linking portion.

According to this wire harness, by the trunk-line-side linking portion of the connector protecting member and the branch-line-side linking portion being linked and fixed respectively to the trunk line harness and the branch line connector, in other words, by the branch line connector being linked to the trunk line harness via the connector protecting member, relative displacement between the branch line connector provided at the branch line harness and the trunk line connector provided at the trunk line harness can be restricted regardless of a load acting on the branch line harness, and thus the abrasion of contact portion of both of the connectors caused by the relative displacement can be prevented, and separation of the connectors can be reliably prevented.

In the connector protecting member, it is preferable that the branch-line-side linking portion and the branch line connector each have an engaging part, the engaging parts engaging with each other so as to restrict relative displacement of the branch line connector in the direction in which the branch line connector separates from the trunk-line-side linking portion. In this case, the connector protector further has a binder for the trunk line that binds the trunk line harness and the trunk-line-side linking portion so as to fix the trunk-line-side linking portion to the trunk line harness by winding the binder for the trunk around a peripheral surface the trunk line harness along with the trunk-line-side linking portion, and a binder for the branch line that binds the branch-line-side linking portion and the branch line connector so as to fix the branch line connector to the branch-line-side linking portion by winding the binder for the branch line around the branch line connector along with the branch-line-side linking portion. The binder for the trunk line and the binder for the branch line can fix the trunk-line-side linking portion extending in the longitudinal direction of the trunk line harness in a stable state to the trunk line harness, furthermore, by fixing the branch-line-side linking portion extending so as to branch from the trunk-line-side linking portion to the branch line connector, relative displacement of the branch line connector with respect to the trunk line harness is more effectively suppressed.

In this connector protector, it is preferable that the branch-line-side linking portion and the branch line connector each have an engaging part that engages with each other so as to restrict relative displacement of the branch line connector in the direction to which the branch line connector separates from the trunk-line-side linking portion. The engagement of the engaging parts makes the prevention of relative displacement between the branch line connector and the trunk line connector that is coupled thereto more reliable, and thus makes it possible to protect both of the connectors more effectively.

The connector protector, alternatively, may also include a harness protector serving as the connector protecting member, and the harness protector may have a trunk line harness housing portion that constrains and houses at least that section of the trunk line harness that includes a branch portion that is connected to the trunk line connector, and a connector housing portion that houses the branch line connector and the trunk line connector that is coupled thereto so as to constrain the branch line connector, the trunk line harness housing portion and the connector housing portion being provided in one piece. According to this harness protector, by the trunk line harness housing portion and the connector housing portion respectively constraining and housing the trunk line harness and both of the connectors, relative displacement between the trunk line connector that is connected to the trunk line harness and the branch line connector that is housed in the connector housing portion is effectively restricted, and in addition, the contact of the trunk line harness, the branch line connector, and the branch line connector with the other members outside of the harness protector is prevented, and the protection of these is made more reliable.

In this case, it is preferable that an outer surface of the branch line connector includes a connector-side fitting part that protrudes or has a recess in the direction perpendicular to the longitudinal direction of the branch line harness, and an inner surface of the connector housing portion includes a protector-side fitting part that engages with the connector-side engaging part, restricting relative displacement of the branch line connector in the direction to which the branch line connector separates from the trunk line harness. The engagement of the engaging parts makes the prevention of relative displacement between the branch line connector and the trunk line connector that is coupled thereto more reliable, and thus makes it possible to protect both of the connectors more effectively.

In addition, a method for manufacturing a wire harness is provided in which a trunk line section and a branch line section are divided from each other, and which is capable of protecting the divided sections effectively from a heavy load.

The provided method includes steps of: preparing a trunk line harness in which a plurality of electrical wires are bundled together, a branch line harness in which a plurality of electrical wires are bundled together and which is capable of branching from the trunk-line harness by being connected to an intermediate section of the trunk line harness, a trunk line connector provided in the intermediate section in the trunk line harness, and a branch line connector that is provided at an end portion of the branch line harness and that electrically connects the trunk line harness to the branch line harness by coupling with the trunk line connector; coupling the trunk line connector and the branch line connector, and electrically connecting the electrical wires included in the trunk line harness and the electrical wires included in the branch line harness; and restricting relative displacement between the trunk line connector and the branch line connector in response to a load acting on the branch line harness by connecting and fixing, to the trunk line harness and the branch line connector, a connector protecting member that is shaped so as to be capable of reaching from the trunk line harness to the branch line connector.

According to this manufacturing method, by dividing the trunk line harness from the branch line harness from each other, the combination of the trunk line harness and the branch line harness can be diversified, and the assembly of the whole wire harness can be facilitated. Furthermore, by connecting the trunk line harness and the branch line connector connected to the branch line harness via the connector protecting member, relative displacement between the trunk line connector that is connected to the trunk line harness and the branch line connector is restricted, whereby the abrasion of the contact portion due to relative displacement can be effectively suppressed, and the separation of the connectors can be prevented.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A wire harness comprising:
a trunk line harness that includes a plurality of electrical wires that are bundled together;
a branch line harness that includes a plurality of electrical wires that are bundled together and that is connectable to the trunk line harness, branching from an intermediate section of the trunk line harness;
a trunk line connector provided at the intermediate section of the trunk line harness;
a branch line connector that is provided at an end portion of the branch line harness, and that connects the electrical wires included in the trunk line harness and the electrical wires included in the branch line harness electrically to each other by being coupled with the trunk line connector; and
a connector protector for protecting the trunk line connector and the branch line connector from a load acting on the branch line harness; wherein
the connector protector includes a connector protecting member reaching from the trunk line harness to the branch line connector, and
the connector protecting member includes a trunk-line-side linking portion linked and fixed to the trunk line harness, and a branch-line-side linking portion linked and fixed to the branch line connector, and
relative displacement between the trunk line connector and the branch line connector in response to a load acting on the branch line harness is restricted by the trunk-line-side linking portion and the branch-line-side linking portion being provided in one piece, fixing the relative position of the trunk-line-side linking portion and the branch-line-side linking portion.

2. The wire harness according to claim 1, wherein
the trunk-line-side linking portion extends in the longitudinal direction of the trunk line harness,
the branch-line-side linking portion extends from an intermediate section of the trunk-line-side linking portion toward the branch line connector and the branch line harness, and
the connector protector further has:
a binder for the trunk line that binds the trunk line harness and the trunk-line-side linking portion so as to fix the trunk-line-side linking portion to the trunk line harness by winding the binder for the trunk line around a peripheral surface the trunk line harness along with the trunk-line-side linking portion, and
a binder for the branch line that binds the branch-line-side linking portion and the branch line connector so as to fix the branch line connector to the branch-line-side linking portion by binding the binder for the branch line around the branch line connector along with the branch-line-side linking portion.

3. The wire harness according to claim 2, wherein
the branch-line-side linking portion and the branch line connector each have an engaging part, the engaging parts engaging with each other so as to restrict relative displacement of the branch line connector in the direction in which the branch line connector separates from the trunk-line-side linking portion.

4. The wire harness according to claim 1, wherein
the connector protector includes a harness protector serving as the connector protecting member, and the harness protector has a trunk line harness housing portion that constrains and houses at least that section of the trunk line harness that includes a branch portion that is connected to the trunk line connector, and a connector housing portion that houses the branch line connector and the trunk line connector that is coupled thereto so as to constrain the branch line connector, the trunk line harness housing portion and the connector housing portion being provided in one piece.

5. The wire harness according to claim 4, wherein
an outer surface of the branch line connector includes a connector-side fitting part that protrudes or has a recess in the direction perpendicular to the longitudinal direction of the branch line harness, and an inner surface of the connector housing portion includes a protector-side fitting part that engages with the connector-side engaging part, restricting relative displacement of the branch line connector in the direction to which the branch line connector separates from the trunk line harness.

6. A method for manufacturing a wire harness, comprising steps of:
preparing a trunk line harness in which a plurality of electrical wires are bundled together, a branch line harness in which a plurality of electrical wires are bundled together and which is capable of branching from the trunk-line harness by being connected to an intermediate section of the trunk line harness, a trunk line connector provided in the intermediate section in the trunk line harness, and a branch line connector that is provided at an end portion of the branch line harness and that electrically connects the trunk line harness to the branch line harness by coupling with the trunk line connector;
coupling the trunk line connector and the branch line connector, and electrically connecting the electrical wires included in the trunk line harness and the electrical wires included in the branch line harness; and
restricting relative displacement between the trunk line connector and the branch line connector in response to a load acting on the branch line harness by connecting and fixing, to the trunk line harness and the branch line connector, a connector protecting member that is shaped so as to be capable of reaching from the trunk line harness to the branch line connector.
